(19) United States
(12) Patent Application Publication
(10) Pub. No.: US 2011/0073682 A1
(43) Pub. Date: Mar. 31, 2011

(54) Fuel Injection Valve

(75) Inventors: Yusuke Irino, Kusatsu (JP); Toru Ishikawa, Kitaibaraki (JP); Yasuo Namaizawa, Naka (JP); Hisashi Ohwada, Hitachi (JP); Kiyotaka Ogura, Hitachinaka (JP)

(73) Assignee: Hitachi Automotive Systems, Ltd., Hitachinaka-shi (JP)

(21) Appl. No.: 12/858,306

(22) Filed: Aug. 17, 2010

(30) Foreign Application Priority Data
Sep. 25, 2009 (JP) 2009-219894

(51) Int. Cl. F02M 61/20; F02M 61/04

(52) U.S. Cl. 239/533.6; 239/533.9

(57) ABSTRACT

A fuel injection valve comprises a valve return spring as a coil spring that applies a spring force to a movable valve element toward a valve seat and an adjuster that is used for adjusting a spring force by adjusting the amount of spring compression. The injection valve is provided with parts supporting respectively both ends of the spring in the axial direction, and the parts rotatable in the circumferential direction of the spring.

### CLAIM OF PRIORITY

The present application claims priority from Japanese application serial no. 2009-219894, filed on Sep. 25, 2009, the contents of which are hereby incorporated by references into this application.

### FIELD OF THE INVENTION

The present invention relates to a fuel injection valve for an internal combustion engine, and in particular, relates to a structure thereof for suppressing variation of fuel injection amount due to deformation of a spring used therefor.

### BACKGROUND OF THE INVENTION

Conventionally, in an internal combustion engine of vehicles such as for automobiles, a solenoid type fuel injection valve that is driven by an electric signal from an engine control unit has been used generally.

Such conventionally known fuel injection valve is constituted in such a manner that a solenoid and a yoke are disposed around a cylindrical stator core, the lower portion of the yoke accommodating the solenoid is provided with a nozzle casing in which a movable core including a valve element is disposed. The valve element is applied with a spring force of a valve return spring via the movable core toward a valve seat side (refer to JP-A-10-339240).

When energizing the solenoid, a magnetic circuit is formed routing from the yoke through the stationary core, the movable core and the nozzle element to the yoke, the movable core with the valve element is magnetically attracted to the stationary core side so as to make a gap between the valve element and the valve seat, and thereby fuel is injected through a nozzle hole.

In the above referred to fuel injection valve, by adjusting an entire length of the spring (valve return spring) exerting on the movable core by means of a spring force adjusting member (it's also called as a adjuster), the spring force can be changed to thereby change the valve operation time and as a result, the fuel flow rate characteristic of injection can be adjusted to a desired value. A coil spring although is used generally as the valve return spring, torsion torque (torsion stress) is apt to occur in the coil spring when adjusting the spring by compressing the spring with the adjuster. When the adjuster is press fitted at the time of adjusting, the spring is deformed by means of this torsion torque, thereby, a resistance to the fuel flow in the fuel passage where the spring is disposed varies and variation of the fuel flow rate characteristic in the injector may result therefrom. Further, in the fuel injector in which the spring contacts to the movable core including the valve element, there are occasions when the torsion torque is suddenly released by an impact from the movable core caused during the movable valve element is actuated. Thereby, the spring restores to its original state, as a result of this, the fuel flow rate characteristic may vary.

Further, when the inner side or the outer side of the spring is not guided at its both ends, the deformation of the spring becomes much remarkable.

Incidentally, a fuel injection valve which injects fuel directly into a cylinder for an internal combustion engine is widely diffused recently. In such a direct injection type fuel injection valve, in view of freedom of attachment thereof, a so-called long nozzle type injector as shown in FIG. 7 has been proposed. The so-called long nozzle type injector has a nozzle casing 105 which is provided at the lower portion of the yoke 104 and whose diameter is reduced and whose length is prolonged.

In such a so-called long nozzle type injector, by the prolonged nozzle (long slender) component thereof, the valve element 108 is also reduced in the diameter thereof and prolonged in the length thereof. Such a long slender valve element is comprised of a solid rod for mechanical strength thereof and the solid rod having a needle valve or a ball valve at the top end thereof.

As shown by an arrow in FIG. 7, a flow direction of fuel passing through the inner side of a spring 112 is changed at the end of the spring by the valve element 108 so that the fuel is guided through gaps between coil portions of the spring 112 to a fuel passage provided around the outer surface of the valve element 108. Accordingly, when the spring 112 is compressed by an adjuster 113 at the time of adjusting the fuel flow rate characteristic, since the gaps between coil portions of the spring 112 are narrowed, the fuel flow rate characteristic is reduced.

When the fuel flow rate characteristic varies or reduces in the above manner, such may cause adverse effects to the engine performance, exhaust gas performance and/or the like.

### SUMMARY OF THE INVENTION

The present invention is to provide a fuel injection valve (injector) capable of suppressing variation or reduction of the fuel flow rate characteristic due to deformation of the spring thereof.

(1) In order to achieve the above object, in a fuel injection valve comprising a valve return spring and an adjuster for the valve return spring, the present invention is characterized basically in that parts supporting respectively both ends of the spring in the axial direction are rotatable in the circumferential direction of the spring. Thereby, the generation of torsion torque is suppressed in the spring, and the variation and reduction of the injection fuel flow rate characteristic can be prevented.

(2) In the above (1), preferably, each of the parts supporting respectively both ends of the spring have fit portions that rotatably fit to a part of an inner radius or an outer radius of the spring. Thereby, since an effect of suppressing a spring deformation such due to torsion stress can be obtained, the variation and reduction of the fuel flow rate characteristic can be prevented.

(3) In the above (1), preferably, one of the parts supporting respectively both ends of the spring contacts to an end portion of the spring at the upstream side with respect to a flow of fuel, and the one is provided with a passage for guiding fuel to the outer radius of the spring. Thereby, a reduction of the fuel injection flow rate can be prevented at the time when adjusting the fuel flow rate characteristic.

(4) In the above (1), preferably, one of the parts supporting respectively both ends of the spring is provided with a hole to be a part of a fuel passage and a filter for trapping foreign matter contained in fuel passing through the one of the parts to prevent the foreign matter from flowing into the inside of the fuel injection valve.

According to the present invention, it is possible to suppress variation or reduction of the fuel flow rate characteristic due to deformation of the spring thereof, the present invention can enhance the engine performance and exhaust gas performance.

### BRIEF DESCRIPTION OF THE DRAWINGS

FIG. 1 is a vertical cross sectional view showing an entire constitution of a fuel injection valve representing an embodiment according to the present invention.

FIG. 2 is a diagram showing injection fuel flow rate characteristics.

FIG. 3 is a vertical cross sectional view showing a major constitution of a fuel injection valve representing another embodiment according to the present invention.

FIG. 4 is a vertical cross sectional view showing a major constitution of a fuel injection valve representing still another embodiment according to the present invention.

FIG. 5 is a vertical cross sectional view showing a major constitution of a fuel injection valve representing a further embodiment according to the present invention.

FIG. 6 is a vertical cross sectional view showing a major constitution of a fuel injection valve representing a still further embodiment according to the present invention.

FIG. 7 is a vertical cross sectional view showing an entire constitution of a conventional fuel injection valve and the fuel passage thereof.

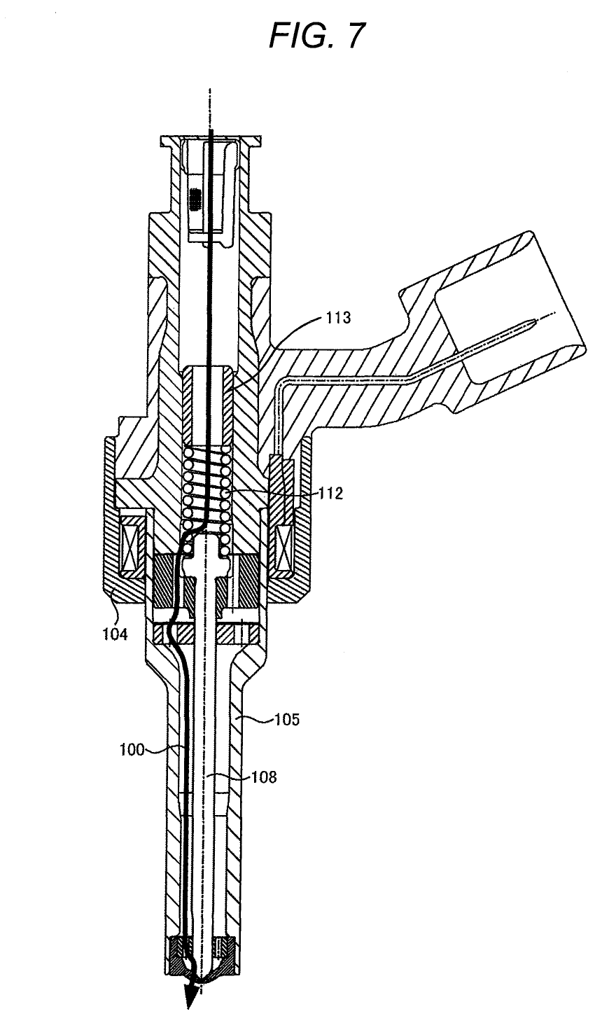

### DETAILED DESCRIPTION OF THE PREFERRED EMBODIMENTS

Preferred embodiments of the present invention will be explained with reference to the embodiments shown in the drawings.

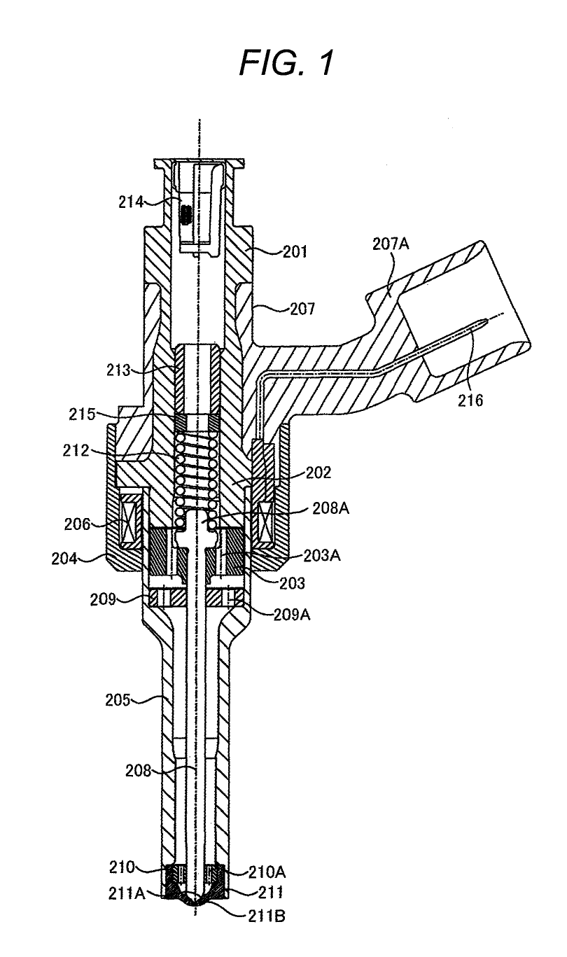

FIG. 1 is a vertical cross sectional view showing an entire constitution of a fuel injection valve (hereafter it's called as injector) representing an embodiment according to the present invention. A injector 201 of the present embodiment is the one so-called as a top feed type in which fuel flows into the upper portion of the injector-main body at the time of valve open, after that, flows through in an axial direction of the injector and is injected from nozzle holes 211B provided at the lower end of the injection valve. The injector 201 is the one that directly inject fuel such as gasoline into a cylinder (combustion chamber) of an engine.

The injector 201 includes an cylindrical stationary core 202, a movable core 203, a yoke 204 serving also as a injection parts-housing and a nozzle casing (it's also called as a nozzle holder) 205. The stationary core 202, the movable core 203, the yoke 204 and a solenoid 206 are of components for a magnetic circuit. The solenoid 206 constitutes an actuator for actuating the movable core together with the valve element.

The stationary core 202, the yoke 204 and the nozzle casing 205 are connected to each other by welding. Although there are varieties of connection manners therefor, in the present embodiment, the stationary core 202 and the nozzle casing 204 are connected by welding under a manner where a part of the inner side of the nozzle casing 205 is fitted to a part of the outer side of the stationary core 202. Further, the nozzle casing 205 and the yoke 204 are connected by welding so as to surround a part of the outer side of the nozzle casing 205 with the yoke 204. The solenoid 206 is assembled inside the yoke 204. The solenoid 206 is covered by parts of the yoke 204, a resin body 207 and the nozzle casing 205 while keeping sealing ability.

Inside the nozzle casing 205, the movable core 203 and a rod shaped valve element 208 connected to the movable core 203 by welding are assembled in a manner to be movable in the axial direction of the nozzle casing. In the present embodiment, a needle type valve element whose top end is tapered is shown as the rod shaped valve element 208. Instead of it, a type of valve element provided with a ball body at the top end thereof can also be used. Further, although the rod shaped valve element 208 of the present embodiment is shown as connected to the movable core 203 by welding, instead of it, it may be used as the following separate type valve element in which the movable core and the valve element are merely contacted to each other with engagement without welding. In the type where the rod shaped valve element 208 and the movable core 203 are separated, a spring (not shown in Figs.) other than a valve return spring 212 is provided between a guide member 209 for the valve element 208 and the movable core 203 so as to engage the movable core 203 to the valve element 208 by applying the spring force thereof toward the stationary core 202 (in the opposite direction of the force of the valve return spring 212) with the force weaker than that of the spring 212.

Inside of the nozzle casing 205 is provided with an upper guide members 209 and a lower guide member 210 that are spaced in a vertical direction so as to guide movably the movable core 203 and the rod shaped valve element 208 in an axial direction of the nozzle casing.

The end of the nozzle casing 205 is provided with a nozzle top 211 which is fixed by welding, and constitutes a part of the nozzle casing 205. The nozzle top 211 is provided with a conical face 211A including a valve seat portion and a plurality of nozzle holes (orifices) 211B.

Inside of the stationary core 202 is provided with a valve return spring 212 that presses the movable core 203 and the rod shaped valve element 208 toward the valve seat portion of the conical face 211A, an adjuster 213 that adjusts the force of the spring 212 and a filter 214 having filtering function.

Further, a rotatable member 215 being shaped like a ring plate, a sleeve or the like with a hole to be a part of a fuel passage is interposed between the spring 212 and the adjuster 213. Since a slight gap is provided between the outer diameter of the rotatable member 215 and the inner diameter of the stationary core 202, the rotatable member 215 is permitted to rotate in an inner circumferential direction of the stationary core 202 (in other words, in a circumferential direction of the spring 212). In addition, the movable core 203 with the valve element 208 is also rotatably provided in the nozzle casing 205 in the inner circumference direction of the nozzle casing 205 (in other words, in the circumference of the spring 212).

When opening the injector, the fuel passage in the injector is constituted by the inside of the stationary core 202 including the adjuster 213 and the rotatable member 215, plural through holes 203A provided in the movable core 203, plural through holes 209A provided in the guide member 210, a ring-shaped gap between the conical face 211A containing the valve seat portion and the tip of the valve element 208, and plural nozzle holes (multi-holes) 211B.

The outer side of the stator core 201A is covered by a resin body 207 being provided with a connector portion 207A that feeds energizing current (pulse current) to the solenoid 206, and a part of lead terminal 216 insulated by the resin body 207. The part of the lead terminal 216 is positioned in the connector portion 207A.

When the solenoid 206 accommodated in the yoke 204 is energized by an external driving circuit (not shown) via the lead terminal 216, a magnetic circuit is formed by the stationary core 202, the movable core 203 and the yoke 204, and the movable core 203 is magnetically attracted toward the stationary core 202 against the force of the spring 212. At this moment, the rod shaped valve element 208 moves away from the valve seat of the conical face 211A to thereby make the valve open state. Thereby, fuel that is pressurized (to more than 10 MPa) within the injector main body in advance by an external high pressure fuel pump (not shown) is injected via the multi-injection holes 211B.

When the energization to the solenoid 206 is turned OFF, the valve element 208 is pressed onto the seat portion of the conical face 211A by the force of the spring 212 to thereby make the valve closed state.

By controlling the energization time to the solenoid 206 depending on the operating conditions of the engine, the injection fuel flow rate can be controlled corresponding to the operating conditions of the engine.

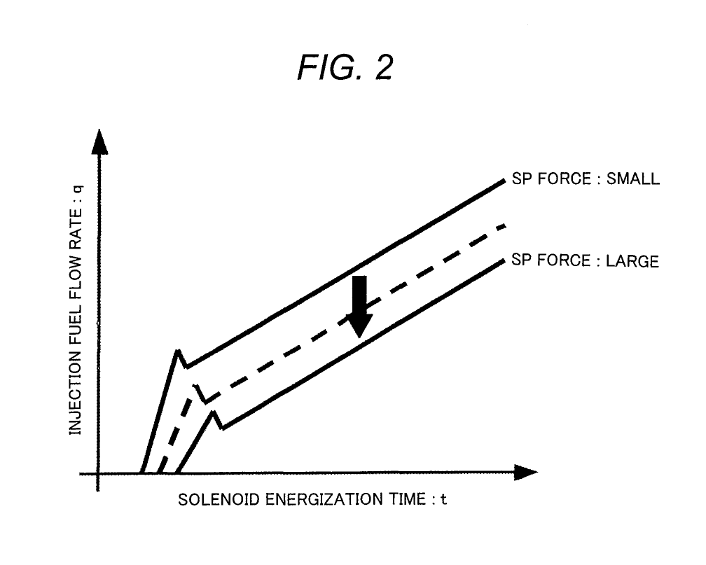

FIG. 2 shows fuel flow rate characteristics representing relationships between the solenoid energization time and injection fuel flow rate. For the fuel injector 201 of the present embodiment, the adjustment work is performed by adjusting the force of the spring 212 (namely the amount of compression of the spring 212) by adjusting the position of the adjuster 213 so that the fuel flow rate characteristic matches with that registered in advance in a control unit (not shown) for controlling the engine.

When the spring 212 is of a coil spring, the coil spring is apt to generate a torsion torque in the spring 212 when adjusting the force of the spring 212 by adjusting the amount of spring compression in the axial direction with the adjuster 213. However, according to the present embodiment, since the movable core 203 and the valve element 208 to which one end of the spring 212 contacts and the rotatable member 215 to which the other end of the spring 212 contacts are rotatable in the inner circumferential direction of the nozzle casing 205 (in other words, in the circumferential direction of the spring 212), the torsion torque can be canceled out with rotational displacement of both rotatable parts (namely the rotatable member 215 and the movable core 203 with the valve element 208).

Therefore, the present embodiment can prevent such variation of the injection fuel flow rate characteristic that are caused by variation of the flow passage resistance because of variation of gaps where the fuel passes due to the deformation of the spring 212, and can enhance engine performance and exhaust gas performance.

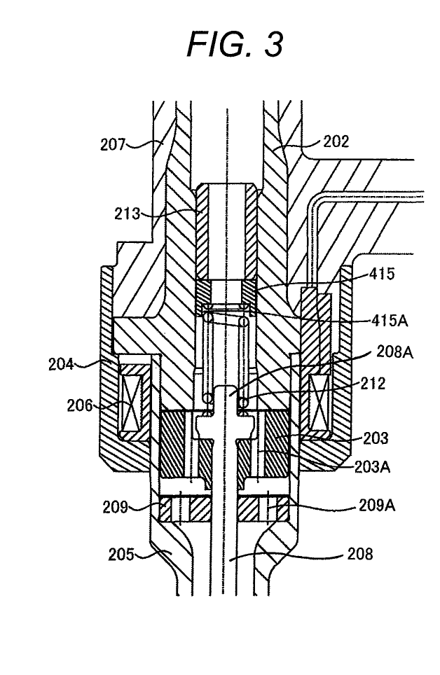

Now, constitutions of fuel injectors representing other embodiments according to the present invention will be explained by making use of FIGS. 3, 4, 5 and 6. Further, the same reference numerals in the drawings as those in FIG. 1 show the same parts as those in FIG. 1.

FIG. 3 is a vertical cross sectional view showing a major constitution of a fuel injector representing another embodiment according to the present invention. A rotatable member 415 corresponds to the rotatable member 215 of FIG. 1. Since the rotatable member 415 like a sleeve shape has a slight gap between the outer diameter of the rotatable member 415 and the inner diameter of the stationary core 202, the rotatable member 415 is rotatable in the inner circumferential direction of the stationary core 202.

Additionally the rotatable member 415 is provided with a recess portion 415A at a bottom thereof. The inner radius of the recess portion 415A is slightly larger than the outer radius of the spring 212. Thereby, a part of the outer radius of one end side of the spring 212 fits into the recess portion 415A. In addition, a part 208A of the upper side of the valve element 208 protrudes toward the spring 212. The outer radius of the upward protruding part 208A is slightly smaller than the inner radius of the spring 212, and thereby the protruding part 208A fits into the inner radius of the spring 212. In other words, the parts (415, 208) supporting respectively both ends of the spring 212 have fit portions that rotatably fit to a part of an inner radius or an outer radius of the spring. Therefore, the spring 212 is prevented from being deformed and is positioned at the center of the inner diameter of the stationary core 202, and the fuel flow is stabilized.

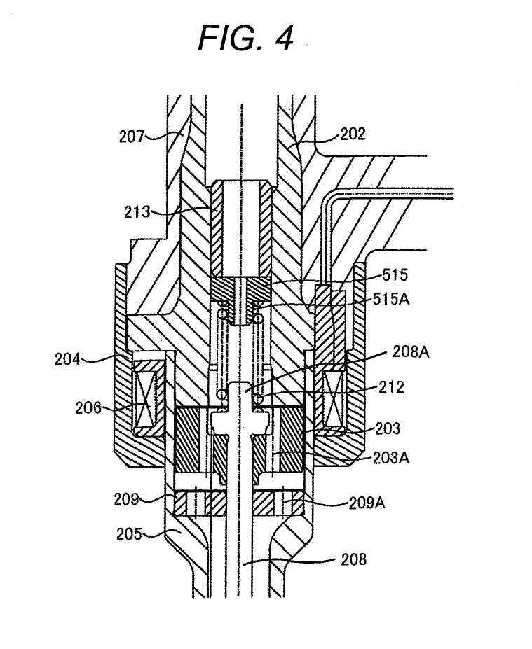

FIG. 4 is a vertical cross sectional view showing a major constitution of a fuel injector representing still another embodiment according to the present invention. A rotatable member 515 corresponds to the rotatable member 215 of FIG. 1. Since the rotatable member 515 like a sleeve shape has a slight gap between the outer diameter of the rotatable member 515 and the inner diameter of the stationary core 202 too, the rotatable member 515 is rotatable in the inner circumferential direction of the stationary core 202.

Additionally the rotatable member 515 is provided with a downward protruding portion 515A with a part of the fuel passage toward the spring 212 at a bottom thereof. The outer radius of the protruding portion 515A is slightly smaller than the inner radius of the spring 212. Thereby, a part of the inner radius of one end side of the spring 212 fits into the protruding portion 515A. In addition, as well as the other embodiments of FIGS. 1 and 3, a part 208A of the upper side of the valve element 208 protrudes toward the spring 212 and the protruding part 208A fits to the inner radius of the spring 212. Therefore, the spring 212 is prevented from being deformed and is positioned at the center of the inner diameter of the stationary core 202, and the fuel flow is stabilized.

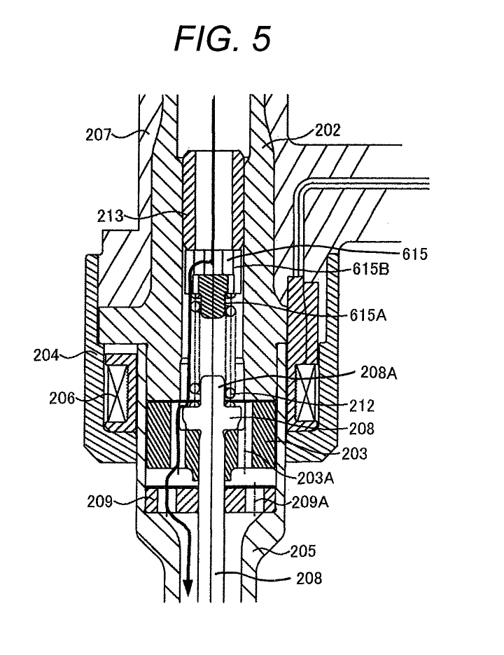

FIG. 5 is a vertical cross sectional view showing a major constitution of a fuel injector representing a further embodiment according to the present invention. A rotatable member 615 corresponds to the rotatable member 215 of FIG. 1. Since the rotatable member 615 like a sleeve shape has a slight gap between the outer diameter of the rotatable member 615 and the inner diameter of the stationary core 202 too, the rotatable member 615 is rotatable in the inner circumferential direction of the stationary core 202.

Additionally, the rotatable member 615 includes a downward protruding portion 615A which protrudes toward the spring 212 at the bottom thereof. The outer radius of the protruding portion 615A is slightly smaller than the inner radius of the spring 212. Thereby, a part of the inner radius of one end side of the spring 212 fits to the protruding portion 615A. In addition, as well as the other embodiments of FIGS. 1 3, and, a part 208A of the upper side of the valve element 208 protrudes toward the spring 212 and the protruding part 208A fits into the inner radius of the spring 212.

Therefore, the spring 212 is prevented from being deformed and is positioned at the center of the inner diameter of the stationary core 202, and the fuel flow is stabilized.

Furthermore, in the present embodiment, a center hole (to be a part of the fuel passage) of the rotatable member 615 is closed at the downstream end by the protruding portion 615A. In addition, the rotatable member 615 is provided with plural of radial grooves extending from the inner circumference to the outer circumference thereof at just upstream from the protruding portion 615A. Thereby, the fuel flow is leaded to a gap between the inner radius of the stationary core 202 and the outer radius of the spring 212 instead of being leaded to inner radius side of the spring 212. Accordingly, since no fuel flows through the gaps between coils of the spring 212, the flow rate thereof is further stabilized.

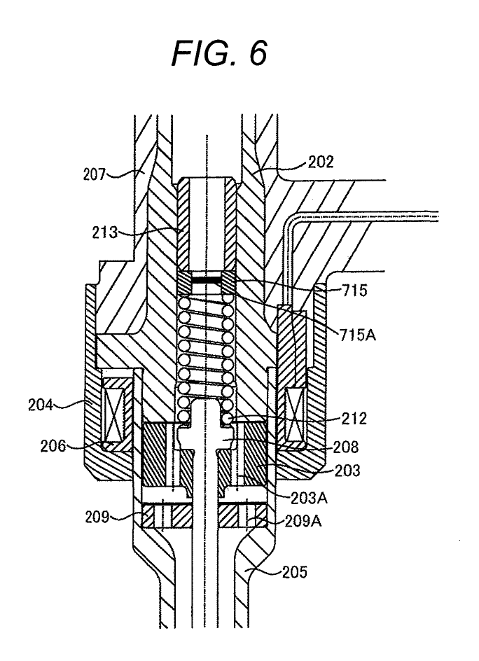

FIG. 6 is a vertical cross sectional view showing a major constitution of a fuel injector representing a still further embodiment according to the present invention. A rotatable member 715 corresponds to the rotatable member 215 of FIG. 1. The present invention has a same structure of the embodiment of FIG. 1 other than the following technical matter. That is, the rotatable member 715 is provided with a filter 715A in the inner radius side (hole) of thereof to be a part of the fuel passage. Thereby, foreign matter (primarily, metals, high polymer compounds and the like) can be trapped to prevent the foreign matter from flowing into the inside of the fuel injection valve. As a result, a possible risk of seat defect due to biting of the foreign matter can be avoided.

Incidentally, when the flow passage area of the fuel passage in the rotatable members 215, 415, 515, 615 and 715 is decreased extremely in comparison with the flow passage area at the upstream of them, an influence of fuel pressure ripple caused when pressurized (to more than 10 MPa) in advance at the external high pressure fuel pump (not shown) is eliminated, and the variation of the fuel injection amount can be suppressed.

Further, in the explanation hitherto, although the fuel injector of in cylinder injection type has been referred to, the present invention is also applicable to a fuel injector that is disposed in an air intake passage.

What is claimed is:

1. A fuel injection valve comprising a valve return spring as a coil spring that applies a spring force to a movable valve element toward a valve seat and an adjuster that is used for adjusting a spring force by adjusting the amount of spring compression, characterized in that parts supporting respectively both ends of the spring in the axial direction are rotatable in the circumferential direction of the spring.

2. The fuel injection valve according to claim 1, wherein one of the parts supporting respectively both ends of the spring is a rotatable member like a ring plate shape or a sleeve shape that is interposed between the adjuster and one end of the spring, and the other of the parts is a movable core joined to the movable valve element, the movable core is actuated together with the movable valve element by a solenoid.

3. The fuel injection valve according to claim 1, wherein each of the parts supporting respectively both ends of the spring have fit portions that rotatably fit to a part of an inner radius or an outer radius of the spring.

4. The fuel injection valve according to claim 1, wherein one of the parts supporting respectively both ends of the spring contacts to an end portion of the spring at the upstream side with respect to a flow of fuel, and the one is provided with a passage for guiding fuel to the outer radius of the spring.

5. The fuel injection valve according to claim 1, wherein one of the parts supporting respectively both ends of the spring contacts to an end portion of the spring at the upstream side with respect to a flow of fuel, the one is provided with a hole to be a part of a fuel passage and a filter for trapping foreign matter contained in fuel passing through the one of the parts to prevent the foreign matter from flowing into the inside of the fuel injection valve.
